(19) United States
(12) Patent Application Publication
(10) Pub. No.: US 2013/0036069 A1
(43) Pub. Date: Feb. 7, 2013

(54) Quality Control Utilizing Automated And Manual Determinations

(71) Applicants: Ghassan Salloum, Seattle, WA (US); Anderthan Hsieh, Bellevue, WA (US)

(72) Inventors: Ghassan Salloum, Seattle, WA (US); Anderthan Hsieh, Bellevue, WA (US)

(73) Assignee: Microsoft Corporation, Redmond, WA (US)

(21) Appl. No.: 13/198,713

(22) Filed: Aug. 5, 2011

(51) Int. Cl. G06Q 30/02

(52) U.S. Cl. 705/347

(57) ABSTRACT

A reputation quality control environment and methodology utilizes periodic automated product scoring and timely manual product reviews to ensure the accuracy of product rankings. The reputation quality control environment has a reputation scale that is divided into one or more reputation bands with product placement within each successively higher band signifying a more desirable product. Products included within the quality control environment are periodically automatically scored based on one or more product characteristic values. Products whose reputation score renders them eligible for a new, higher reputation band are manually reviewed prior to being allowed into the higher band. Products whose product reputation score is on a trajectory that indicates the product will likely attempt to enter a new, higher reputation band within a predetermined timeframe are timely manually reviewed so that acceptable products can be instantaneously allowed into the new band when their reputation score provides for it.

### BACKGROUND

There are a variety of reputation environments where products onboarded, i.e., accepted into and showcased within, the environment are scored and rated based on various combinations of product reputation category values. However, product scores can be unscrupulously manipulated which allows for products to be improperly scored and ranked within the reputation environment. Product score manipulation ultimately can render the reputation environment untrustworthy and unusable as users of the environment will often be disappointed and, ultimately, dissuaded from relying on a faulty reputation environment that erroneously showcases products.

Thus, it is desirable to have a system and methodology for ensuring the accuracy and integrity of a reputation environment. Further it is desirable to confirm product rankings within a reputation environment in a timely manner so that the reputation environment can, at any given time, adequately and accurately reflect product rankings for products showcased therein.

### SUMMARY

This summary is provided to introduce a selection of concepts in a simplified form which are further described below in the Detailed Description. This summary is not intended to identify key or essential features of the claimed subject matter, nor is it intended to be used as an aid in determining the scope of the claimed subject matter.

Embodiments discussed herein include systems and methodology for integrating automatically generated product scores with timely manual product reviews to ensure that products hosted, or otherwise onboarded, within a reputation quality control environment are accurately positioned relative to one another and consistent with their quality. In embodiments timely manual product reviews are scheduled and performed prior to a product attempting to move into a higher reputation band of a reputation scale on which onboard products are positioned within a reputation quality control environment. In these embodiments products can be positioned within a higher reputation band when their automatically generated reputation score falls within the higher reputation band and the prior manual product review has determined that the product is acceptable for placement within the higher reputation band.

### BRIEF DESCRIPTION OF THE DRAWINGS

These and other features will now be described with reference to the drawings of certain embodiments and examples which are intended to illustrate and not to limit, and in which:

FIG. 1 depicts an embodiment reputation quality control environment that meshes automated and manual determinations.

FIG. 2 depicts embodiment product reputation categories whose values can be used for scoring and ranking products onboarded within a reputation quality control environment.

FIG. 3 depicts embodiment exemplary reputation band assignments over time for various onboard product examples.

FIGS. 4A-4B depict an embodiment logic flow for onboarding a new product into a reputation quality control environment.

FIGS. 5A-5C depict an embodiment logic flow for managing onboard products on a reputation scale within a reputation quality control environment.

FIGS. 6A-6B depict an embodiment logic flow for incorporating manual determinations within an embodiment reputation quality control environment.

FIG. 7 is a block diagram of an exemplary basic computing device with the capability to process software, i.e., program code, or instructions.

### DETAILED DESCRIPTION

In the following description, for purposes of explanation, numerous specific details are set forth in order to provide a thorough understanding of embodiments described herein. It will be apparent however to one skilled in the art that the embodiments may be practiced without these specific details. In other instances well-known structures and devices are either simply referenced or shown in block diagram form in order to avoid unnecessary obscuration. Any and all titles used throughout are for ease of explanation only and are not for any limiting use.

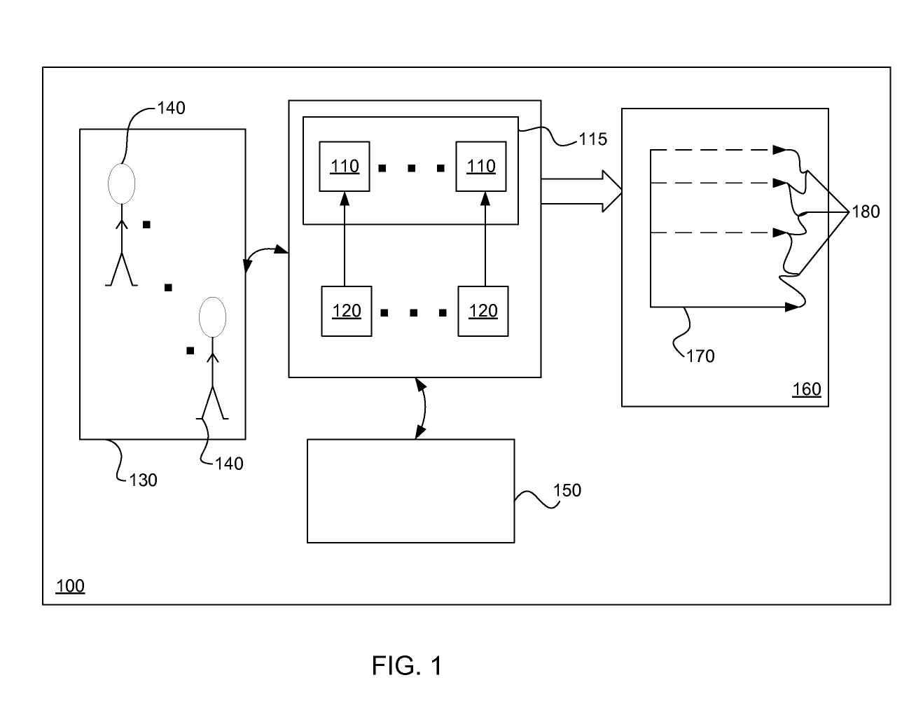

Referring to FIG. 1, an embodiment reputation quality control environment 100 utilizes both manual, i.e., user, also referred to herein as reviewer, 140, product scoring and reputation rankings, i.e., reputation determinations, and automated, i.e., software 150 driven, reputation determinations to generate product scores and rankings 160 for one or more products 110. In an embodiment product scores and rankings 160, also collectively referred to herein as product rankings 160 or onboard product rankings 160, are the scores and resultant rankings for products 110 that seek to be showcased, i.e., presented, within the reputation quality control environment 100.

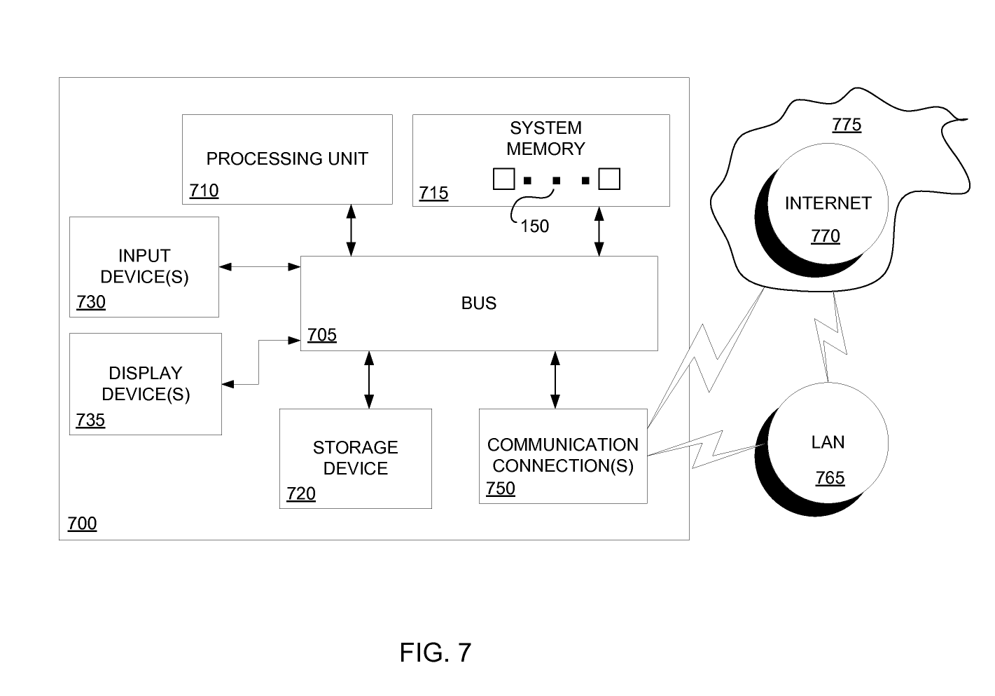

In embodiments the reputation quality control environment 100 can be used to score, rate and/or rank, collectively also referred to herein as score, virtually any group of one or more entities, generically referred to herein as products 110. The groups of products 110 that can be scored in an embodiment reputation quality control environment 100 includes any group of one or more products 110 that are amenable to being scored, rated and/or ranked. A small sampling of exemplary products 110 that can be scored in an embodiment reputation quality control environment 100 includes, but is not limited to, software applications for free or sale for use on various computing devices 700 as depicted in FIG. 7; books for sale in a traditional, e.g., bricks and mortar, building or online store; books available for borrowing in either a traditional or online library; restaurants; dishes served in any particular restaurant(s); recipes; art; parks; hotels; cars; etc.

In embodiments a computing device 700, as depicted in FIG. 7, is any device capable of executing software, e.g., a desktop computer, a laptop, a cellular phone, a smart phone, etc.

In an embodiment the reputation quality control environment 100 utilizes manual reputation determinations. In an aspect of this embodiment one or more users 140 review and/or exercise, e.g., activate, run, execute, etc., various products 110 that are currently onboarded within the reputation quality control environment 100. In an aspect of this embodiment one or more users 140 review and/or exercise various new products 110 that are seeking to be onboarded within the reputation quality control environment 100.

In an embodiment manual, i.e., user 140 driven, reputation determinations are performed independently of automated, i.e., software 150 driven, reputation determinations and the input(s) utilized in rendering automated reputation determinations. In an alternative embodiment manual reputation determinations refer to, utilize and/or take into account automated reputation determinations and/or one or more input(s) utilized in rendering automated reputation determinations.

In an embodiment the reputation quality control environment 100 utilizes automated reputation determinations. In an aspect of this embodiment one or more procedures 150 are executed on a computing device, e.g., computing device 700 of FIG. 7, to generate automated reputation determinations for various products 110 that are currently onboarded within the reputation quality control environment 100 as well as new products 110 that are seeking to be onboarded. In embodiments a procedure 150, also referred to herein as an application, program, software or software code, is a set of instructions that upon execution performs a specific task, or function, for a computing device 700. In embodiments a procedure 150, when executed, tells a computing device 700 what to do and how to accomplish it, e.g., what to score and/or rank a particular product 110. In embodiments a procedure 150 can include data used by the set of instructions to accomplish the designed functionality.

In an embodiment the software 150 for generating automated reputation determinations takes into account and/or otherwise utilizes one or more product reputation values 120 for a product 110 that is being automatically scored and/or ranked.

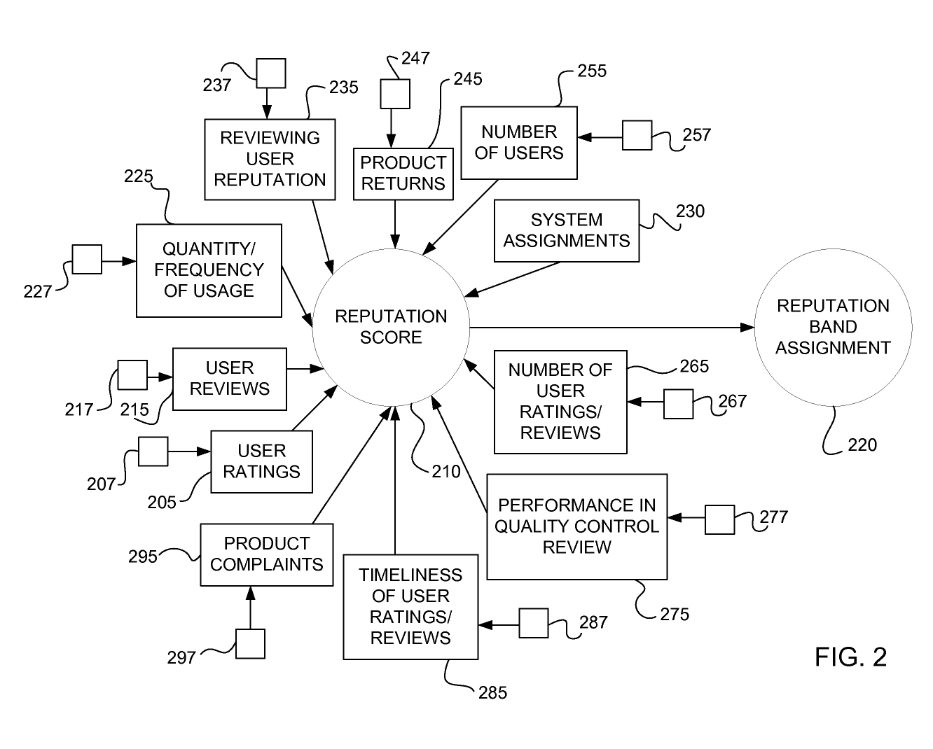

Referring to FIG. 2, various embodiment product reputation categories are depicted which, in any combination, can be used to automatically determine a reputation score 210 for a product 110. In an embodiment a reputation score 210 is a number that is assigned to a product 110 and is reflective of the product's quality, capabilities, innovativeness, desirability, and/or etc., collectively referred to herein as a product's quality.

Referring again to FIG. 1, in an embodiment reputation scores 210 are used to determine if a product 110 is acceptable for onboarding within the reputation quality control environment 100, and if so, to assign a product 110 to a reputation band 180 within a reputation scale 170 for the reputation quality control environment 100.

In an embodiment a reputation scale 170 is used to rank the products 110 onboarded within the reputation quality control environment 100. In an embodiment a reputation scale 170 can include one or more reputation bands 180.

In an embodiment a reputation band assignment 220 is the reputation band 180 that a product 110 is assigned to on a reputation scale 170 within a reputation quality control environment 100. In an embodiment a reputation band 180 is a class, or group, of a range of reputation scores 210. For example, an embodiment reputation scale 170 may contain a reputation score range from zero (0) to one hundred (100), a first reputation band 180 may include reputation scores 210 from zero (0) to twenty-five (25), a second reputation band 180 and may include reputation scores 210 from twenty-six (26) to seventy-five (75) and a third reputation band 180 may include reputation scores 210 from seventy-six (76) to one hundred (100).

In an embodiment differing reputation bands 180 provide differing levels of product handling within the reputation quality control environment 100.

In an embodiment the lowest reputation band 180 allows products 110 to be onboarded within the reputation quality control environment 100 but otherwise provides minimal and/or the weakest product support, e.g., nominal or no product advertising, nominal product exposure, nominal or no product endorsement, and/or etc.

In an embodiment middle reputation band(s) 180, i.e., the reputation bands 180 between the lowest reputation band 180 and the highest reputation band 180, provide differing degrees of product support that include more product support than what products in the lowest reputation band 180 receive but less product support than what products 110 in the highest reputation band 180 receive. In an aspect of this embodiment each increasingly higher middle reputation band 180 provides incrementally more and/or stronger product support than the previous, lower, middle reputation band 180.

In an embodiment the highest reputation band 180 provides the maximum and/or strongest product support within the reputation quality control environment 100, e.g., strong product advertising, maximum product exposure, strong product endorsement, and/or etc.

In an embodiment product reputation values 120 from one or more product reputation categories are used to derive a reputation score 210 for a product 110. In an embodiment reputation scores 210 are computed when a product 110 initially seeks entrance to the reputation quality control environment 100. In an embodiment reputation scores 210 are computed periodically, e.g., once a day, once a week, etc., for onboard products 110 within the reputation quality control environment 100.

Referring again to FIG. 2, in an embodiment user ratings 205 is a product reputation category utilized for deriving reputation scores 210. In an embodiment a user ratings value is a number assigned to a product 110 that is intended to be reflective of the product's quality, usability, desirability and/or etc. In an embodiment a user ratings 205 can also, or alternatively, be an icon assignment, e.g., star assignment, where the number of an icon assigned to a product 110 is intended to be indicative of the product's quality, usability, desirability and/or etc. In an aspect of this embodiment the quantity of an icon utilized for denoting a user ratings 205, e.g., stars, thumbs up, smiley faces, etc., is translated into a corresponding numeric value, e.g., three stars correlates to a numeric value of three for a user ratings 205.

In an embodiment a user ratings 205 value is assigned to a product 110 by a user of the product. In aspects of this embodiment a user of a product 110 can be a reviewer 140 and/or a consumer of the product 110, e.g., a purchaser of the product 110, an individual who utilizes the product 110, an individual who accesses the product 110, etc.

In an embodiment user ratings values are weighted 207 when utilized to generate a reputation score 210. In an embodiment the user ratings value weight 207 is a predetermined weighting value, or number.

In an embodiment user reviews 215 is a product reputation category utilized for deriving reputation scores 210. In an embodiment user reviews 215 are text descriptions of a product 110 and/or what a user of a product 110 thinks about the product 110. In an embodiment software 150 is employed to scan a user reviews 215 and assign a numeric value to the user reviews 215 based on various words contained within the user reviews 215. For example, a user reviews 215 that contains words and/or phrases such as “excellent,” “love it,” “best,” etc. may be given a high user reviews 215 value, e.g., five (5) out of a possible five (5). As a second example, a user reviews 215 that contains words and/or phrases such as “awful,” “terrible,” “hate it,” “cannot recommend it,” etc. may be given a low user reviews 215 value, e.g., zero (0) out of a possible five (5).

In an embodiment user reviews values are weighted 217 when utilized to generate a reputation score 210. In an embodiment the user reviews value weight 217 is a predetermined weighting value, or number.

In an embodiment quantity/frequency of usage 225 is a product reputation category utilized for deriving reputation scores 210. In an embodiment quantity/frequency of usage 225 is a numeric value that identifies the quantity of a product 110 sold and/or the frequency with which the product 110 is utilized, e.g., how often a book product 110 is borrowed from the library, the number of a book product 110 sold, the number of customers in a restaurant product 110 on any given night, the number of visitors to a particular tourist attraction product 110 on any given day, etc.

In an embodiment quality/frequency of usage values are weighted 227 when utilized to generate a reputation score 210. In an embodiment the quality/frequency of usage value weight 227 is a predetermined weighting value, or number.

In an embodiment reviewing user reputation 235 is a product category utilized in deriving reputation scores 210. In an embodiment reviewing user reputation 235 is a numeric value that reflects the reputation of a user of a product 110 who is producing one or more user reviews 215 for a product 110. For example user A may always submit user reviews 215 that claim a reviewed product 110 is wonderful which can diminish user A's reviews' use in accurately reflecting the quality of products 110. Thus, in this example user A may be given a low user reputation value, e.g., one (1) out of a possible five (5). As another example user B may generally submit user reviews 215 that mirror independent reviewer 140 reputation determinations and thus are deemed to accurately assist in scoring and ranking products 110. Therefore in this example user B may be given a high user reputation value, e.g., five (5) out of a possible five (5).

In an embodiment reviewing user reputation values are weighted 237 when utilized to generate a reputation score 210. In an embodiment the reviewing user reputation value weight 237 is a predetermined weighting value, or number.

In an alternative embodiment a reviewing user reputation 235 value is utilized in conjunction with a user ratings 205 value and/or user reviews 215 value for a product 110, and effectively, is used as, or in combination with, the user ratings weight 207 and/or user reviews weight 217.

In an embodiment product returns 245 is a product category utilized in deriving product reputation scores 210. In an embodiment product returns 245 is a numeric value indicative of the number of returns of a product 110, i.e., the quantity of a product 110 that is given back because the user does not like it or want it.

In an embodiment product returns values are weighted 247 when utilized to generate a reputation score 210. In an embodiment the product returns value weight 247 is a predetermined weighting value, or number.

In an embodiment number of users 255 is a product category utilized in deriving product reputation scores 210. In an embodiment number of users 255 is a numeric value indicative of the quantity of users of a product 110, e.g., the number of purchasers of the product 110, the number of people who borrowed the book product 110 from a library, the number of customers to a restaurant product 110, etc.

In an embodiment number of users values are weighted 257 when utilized to generate a reputation score 210. In an embodiment the number of users value weight 257 is a predetermined weighting value, or number.

In an embodiment system assignments 230 is a product category utilized in deriving product reputation scores 210. In an embodiment a reputation score 210 for a product 110 is set to the system assignment value for the product 110 if the product 110 is provided a system assignment value. Thus, in this embodiment a system assignment value supersedes other product category values otherwise used to derive a reputation score 210 for a product 110.

In an embodiment a system assignment value is a numeric reputation score value assigned to a product 110 by a reviewer 140 or automated reviewing software 150. In an embodiment a system assignment value is intended to more accurately reflect a reputation score 210 for a product 110 than a reputation score value automatically derived utilizing other product category values, e.g., user ratings 205 value, product returns 245 value, etc. In an embodiment a system assignment value may alternatively reflect a reputation score 210 for a product 110 and ultimately, a product reputation ranking, that does not exist utilizing other product category values but is desired for a particular product 110.

In an embodiment number of user ratings/reviews 265 is a product category utilized in deriving product reputation scores 210. In an embodiment number of user ratings/reviews 265 is a value indicative of the number of ratings and/or reviews that a product 110 has been given by users of the product 110.

In an embodiment number of user ratings/reviews values are weighted 267 when utilized to generate a reputation score 210. In an embodiment the number of user ratings/reviews value weight 267 is a predetermined weighting value, or number.

In an embodiment performance in quality control review 275 is a product category utilized in deriving product reputation scores 210. In an embodiment performance in quality control review 275 is a reputation score 210 value assigned to a product 110 during a quality control review of the product 110 by a reviewer 140 and/or by automated reviewing software 150. In an embodiment performance in quality control review values for products 110 are derived from predefined standardized product characteristic scale valuations and are intended to reflect nonjudgmental valuations of a product 110.

In an embodiment performance in quality control review values are weighted 277 when utilized to generate a reputation score 210. In an embodiment the performance in quality control reviews value weight 277 is a predetermined weighting value, or number.

In an embodiment timeliness of user ratings/reviews 285 is a product category utilized in deriving product reputation scores 210. In an embodiment timeliness of user ratings/reviews 285 is a numeric value indicative of the timeliness of a product's user ratings and reviews, e.g., how current, or up-to-date, a predetermined percentage, e.g., majority, etc., of the product's ratings and reviews from users of the product 110 are, how current the most recent product user rating and/or review is, how current the last predetermined number, e.g., five, product user ratings and/or reviews are, etc. In an embodiment the more current the user ratings and/or reviews for a product 110 the larger, more desirable, value for the timeliness of user ratings/review for the product 110 will be.

In an embodiment timeliness of user ratings/reviews values are weighted 287 when utilized to generate a reputation score 210. In an embodiment the timeliness of user ratings/reviews value weight 287 is a predetermined weighting value, or number.

In an embodiment product complaints 295 is a product category utilized in deriving product reputation scores 210. In an embodiment product complaints 295 is a value indicative of the number of complaints a product 110 has received.

In an embodiment product complaint values are weighted 297 when utilized to generate a reputation score 210. In an embodiment the product complaint value weight 297 is a predetermined weighting value, or number.

In embodiments combinations of one or more product category values can be used to generate a product reputation score 210.

In embodiments more, less and/or different product category values can be used to generate product reputation scores 210.

In an embodiment products 110 can be automatically scored by the execution of software 150 using combinations of one or more product reputation values 120. In this embodiment products 110 are positioned within a reputation band 180 of a reputation scale 170 based on their automatically generated reputation scores 210. In an embodiment automatically generated reputation scores 210 for products 110 can also be used to determine a product's acceptance into an initial reputation band 180 of the reputation scale 170, to determine a product's acceptance to be onboarded within the reputation quality control environment 100, to determine and/or confirm a product's ranking and/or positioning with the reputation scale 170, and/or etc.

In an embodiment products 110 are manually reviewed by one or more reviewers 140 to determine their reputation score 210, to determine their reputation band assignment 220, to determine their acceptance into a particular reputation band 180 of the reputation scale 170, to determine their acceptance to be onboarded within the reputation quality control environment 100, to determine and/or confirm their ranking and/or positioning within the reputation scale 170, and/or etc.

In an embodiment a manual review of a product 110 is scheduled to be performed when a change in the product's reputation score 210 causes the product 110 to seek acceptance into a new, higher reputation band 180.

In an embodiment a manual review of a product 110 is scheduled to be performed when the velocity of the increase of a product's reputation score 210 indicates that the product 110 is likely to seek acceptance into a new, higher reputation band 180 within a predetermined manual review threshold time interval. In this embodiment a determination is made as to whether a current onboard product 110 is likely to obtain a product reputation score 210 that will position the product 110 within a new, higher reputation band 180 within a predetermined time interval, e.g., the manual review threshold time interval, given its current reputation score 210 and the rate of ascent that its reputation score 210 has been making.

In an embodiment the manual review threshold time interval is a predefined value set to attempt to ensure that products 110 that attempt to cross into a higher reputation band 180 are timely manually reviewed. In this embodiment a timely manual review allows a product 110 to be positioned within a higher reputation band 180 when the product's reputation score 210 is set within the new, higher reputation band 180 and the prior manual review has confirmed the product's allowance into the new, higher reputation band 180.

In an embodiment the maximum velocity of a product's reputation score 210 within the reputation quality control environment 100 is a known characteristic of the product category values and associated weights used in computing any product's reputation score 210. In an embodiment the velocity of a product's reputation score 210 can be calculated by the product's past and current reputation scores 210. In an embodiment, as the periodic time interval for automatically computing onboard product reputation scores 210 is a set value, the time it will take for a product reputation score 210 to cross into a higher reputation band 180 can be computed and used to determine if the product 110 is within the manual review threshold time interval to be scheduled for a manual review.

In an embodiment a manual review of a new product 110 seeking to be onboarded within the reputation quality control environment 100 is performed prior to accepting the new product 110 for onboarding.

In an embodiment manual reviews of a group of one or more onboard products 110 are periodically performed to ensure that onboard products 110 are being automatically scored correctly; i.e., as an additional check to ensure that the reputation scale 170 remains trustworthy and accurately reflects scores and rankings of onboard products 110.

In an embodiment different levels of manual review are performed on products 110 dependent upon the reputation band 180 that the product 110 is targeted to be assigned to. Thus, in an embodiment the manual review for a product 110 seeking to enter a second, higher reputation band 180 is more strenuous than the manual review for a product 110 targeted to be positioned within the lowest reputation band 180 of the reputation scale 170. Likewise, in this embodiment the manual review for a product 110 seeking to enter the highest reputation band 180 of the reputation scale 170 is the most strenuous.

In an embodiment, once a product 110 has been manually reviewed and accepted for a particular reputation band 180, the product 110 will not be required to be manually reviewed for this same reputation band 180 within a predetermined band allowance timeframe, e.g., a month, half-a-year, etc. One or more onboard products 110, pursuant to their reputation scores 210, may change reputation bands 180 numerous times over the course of a time period, e.g., go from a first, lowest, reputation band 180 to a second, higher, reputation band 180, and back and forth again over time. In an embodiment, as long as the product 110 has been manually reviewed and accepted for each reputation band 180 it enters via its reputation score 210 within the predefined band allowance timeframe the product 110 will not be manually re-reviewed during this band allowance timeframe. In an aspect of this embodiment a product 110 need only have been previously manually reviewed within the band allowance timeframe for each reputation band 180 that it enters other than the lowest reputation band 180 of the reputation scale 170.

In an embodiment if a product 110 is attempting to reenter a reputation band 180 that it was previously manually reviewed and accepted for, but not within the band allowance timeframe, the product 110 will be required to be manually reviewed and reaccepted for the reputation band 180 prior to being accepted into it.

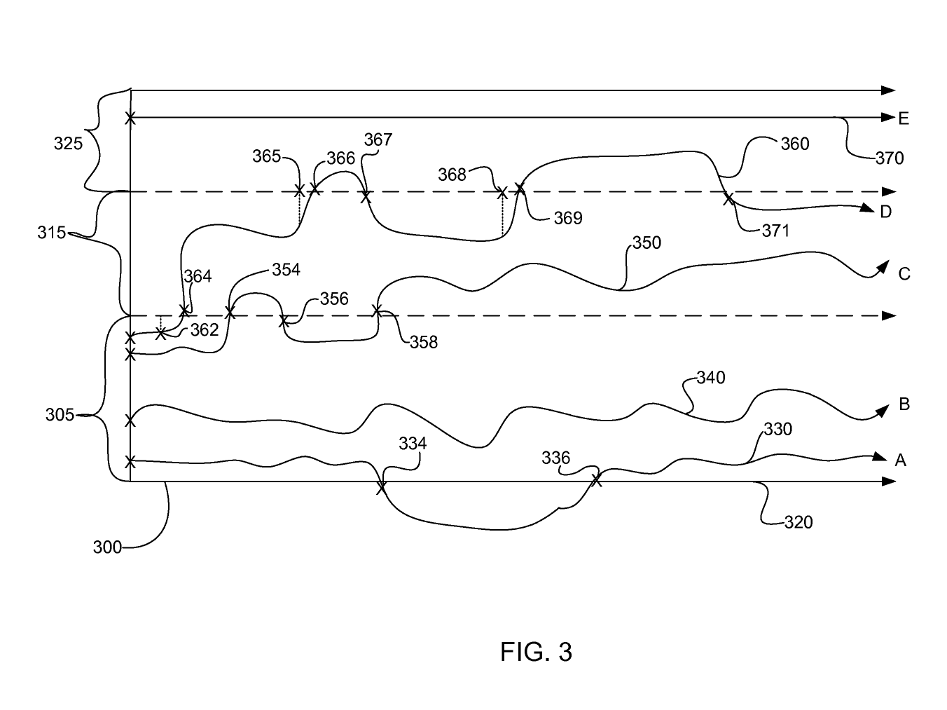

FIG. 3 depicts an embodiment reputation scale 300 for an embodiment reputation quality control environment 100. In FIG. 3 exemplary reputation band assignments are depicted over time 320 for various example onboard products, A 330, B 340, C 350, D 360 and E 370.

The exemplary embodiment reputation scale 300 has three reputation bands 180: a first, lowest, reputation band 305, also referred to herein as the bronze band 305; a second, middle, reputation band 315, also referred to herein as the silver band 315; and a third, highest, reputation band 325, also referred to herein as the gold band 325. The embodiment bronze band 305 encompasses reputation scores 210 from zero (0) to fifty (50). The embodiment silver band 315 encompasses reputation scores 210 from fifty-one (51) to eighty (80). The embodiment gold band 325 encompasses reputation scores 210 from eighty-one (81) to one-hundred (100).

In alternative embodiments reputation scales 300 for various reputation quality control environments 100 can have different numbers of reputation bands 180, e.g., two, five, ten, etc., with differing labels. In alternative embodiments reputation bands 180 can encompass differing ranges of reputation scores 210. In alternative embodiments the reputation scale 170 can encompass differing reputation score 210 ranges, e.g., zero (0) to two-hundred (200), five (5) to 50 (fifty); one (1) to one-thousand (1000), etc.

In the example of FIG. 3 products A 330, B 340, C 350 and D 360 all initially enter the reputation scale 300, i.e., are onboarded within the reputation quality control environment 100 with the reputation scale 300, within the lowest reputation band 180, i.e., the bronze band 305.

In the example of FIG. 3 product E 370 has been given a system assignments 230 value that initially positions product E 370 within the highest reputation band 180, i.e., the gold band 325, of the reputation scale 300. In the example of FIG. 3 product E 370 remains within the gold band 325 throughout the depicted time 320.

In the example of FIG. 3 product A 330, pursuant to its automatically generated reputation scores 210, remains in the lower portion of the bronze band 305 until time 334. At time 334 product A's reputation score 210 falters to the extent that product A 330 is no longer eligible to be onboarded within the reputation quality control environment 100. In the example of FIG. 3 at time 336 product A 330 regains a sufficient reputation score 210 to be once more onboarded within the reputation quality control environment 100.

In an embodiment and the example of FIG. 3, because product A 330 was accepted to be onboarded in the bronze band 305 of the reputation scale 300 and the time 320 between time 334 and time 336 is within a predefined band allowance timeframe, product A 330 is allowed to reenter the reputation quality control environment 100 within the bronze band 305 when its reputation score 210 at time 336 regains sufficient value to fall within the reputation scale's bronze band 305. In an embodiment even though product A 330 was accepted to be onboarded in the bronze band until time 334, if the time 320 between time 334 and time 336 is not within the predefined band allowance timeframe product A 330 would not be allowed to reenter the reputation quality control environment 100 until it was manually reviewed and reaccepted for the bronze band 305.

In the example of FIG. 3, once product A 330 reenters the bronze band 305 of the reputation scale 300 it remains within this bronze band 305 throughout the remaining depicted time 320.

In the example of FIG. 3 product B 340, pursuant to its automatically generated reputation scores 210, remains positioned in the bronze band 305 throughout the depicted time 320. In an embodiment, at some time product B 340 will be manually reviewed for the bronze band 305 while product B 340 remains positioned within the bronze band 305 to ensure that its acceptance and position within the bronze band 305 pursuant to its automatically generated reputation scores 210 is accurate.

In the example of FIG. 3 product C 350, pursuant to its automatically generated reputation scores 210, or, alternatively, an initial system assignments 230 value, initially onboards within the reputation quality control environment 100 in the bronze band 305 of the reputation scale 300. In the example of FIG. 3 at time 354 product C's reputation score 210 is of sufficient value for product C 350 to enter the next higher reputation band 180, i.e., the silver band 315. In an embodiment and this example, at time 354 product C 350 is scheduled for a manual review. In the example of FIG. 3 product C 350 passes the manual review for entering the silver band 315, and thus is allowed to enter the silver band 315.

In the example of FIG. 3 at time 356 product C's reputation score 210 falters sufficiently for product C 350 to be reassigned to the lower, bronze band 305. In an embodiment and the example of FIG. 3, as product C 350 is being repositioned in a lower reputation band 180 there is no need to manually review product C 350 at time 356 and product C 350 can be repositioned in the lower, bronze band 305 at time 356.

In the example of FIG. 3, at time 358 product C's reputation score 210 has increased sufficiently for product C 350 to be repositioned within the silver band 315. In an embodiment, as product C 350 has been previously manually reviewed and accepted for the silver band 315 within a predetermined band allowance timeframe, at time 358 product C 350 is allowed to reenter the silver band 315 without the need for any additional manual review at this time 358.

In an embodiment, if the time 320 between time 354, when product C 350 is first manually reviewed for the silver band 315, and time 358, when product C 350 seeks to reenter the silver band 315, is greater than the band allowance timeframe at time 358 product C 350 is scheduled for a manual review for acceptance into the silver band 315 which product C 350 must once more pass prior to being allowed to reenter the silver band 315.

In the example of FIG. 3 once product C 350 reenters the silver band 315 at time 358 it remains positioned within the silver band 315 for the remaining depicted time 320.

In the example of FIG. 3, product D 360, pursuant to its automatically generated reputation scores 210, or, alternatively, an initial systems assignment 230 value, initially onboards within the reputation quality control environment 100 in the bronze band 305 of the reputation scale 300. At time 364 product D's reputation score 210 is of sufficient value for product D 360 to enter the next higher, silver band 315. In an embodiment and this example, product D's reputation score 210 had sufficient velocity that product D 360 was identified to be pre-reviewed, manually, for acceptance into the silver band 315 at time 362. In an embodiment and this example product D 360 was manually reviewed for the silver band 315 and passed the manual review prior to time 364. In an embodiment, upon passing the manual review for the silver band 315 product D 360 is marked eligible for the silver band 315. In an embodiment and this example at time 364 when product D's reputation score 210 is of sufficient value for product D 360 to be eligible for the silver band 315 product D 360 is positioned within the silver band 315.

In an embodiment and using the example of FIG. 3, if product D 360 did not pass the manual review for the silver band then product D 360 would not have been accepted into the silver band 315. In an aspect of this embodiment, when product D 360 fails its manual review for the silver band 315 it is marked as ineligible for the silver band 315. In this aspect of this embodiment even if product D's automatically generated reputation score 210 establishes product D 360 as eligible for the silver band 315, if product D 360 is marked ineligible for the silver band 315 it will not be allowed to be positioned within the silver band 315 until such time as a manual review of product D 360 ascertains that product D 360 is eligible for the silver band 315.

In an embodiment and using the example of FIG. 3, if product D 360 fails the manual review for acceptance into the silver band 315 product D 360 will be given a system assignments 230 value which will effectively readjust product D's reputation score 210 and ensure that product D 360 remains positioned within the lower, bronze band 305.

In an embodiment, if a product 110 does not pass the manual review for a higher reputation band 180 then the product 110 will not be manually reviewed for any other higher reputation bands 180 within the reputation scale 170, regardless of the product's automatically generated reputation score 210, until such time as the product 110 passes a manual review for the next higher reputation band 180 from the one it is currently positioned in. Thus, for example, in this embodiment if product D 360 does not pass the manual review for the silver band 315, even if product D's automatically generated reputation score 210 establishes product D 360 as eligible for the next higher, gold band 325, product D 360 will not be manually reviewed for the gold band 325 or allowed to be positioned within the gold band 325 until after the time product D 360 can pass the manual review for the lower, silver band 315.

In the example of FIG. 3 at time 366 product D's reputation score 210 is of sufficient value for product D 360 to enter the next higher, gold band 325. In an embodiment and this example product D's reputation score 210 had sufficient velocity that product D 360 was identified to be pre-reviewed, manually, for acceptance into the gold band 325 at time 365. In an embodiment and this example product D 360 passes the manual review for the gold band 325 and is marked eligible for the gold band 325. Thus, in an embodiment and the example of FIG. 3, at time 366 when product D's reputation score 210 is of sufficient value for product D 360 to be eligible for the gold band 325, product D 360 is positioned within the gold band 325.

In the example of FIG. 3 at time 367 product D's reputation score 210 falters sufficiently for product D 360 to be reassigned to the lower, silver band 315. In an embodiment, as product D 360 is being repositioned in a lower reputation band 180 there is no need to manually review product D 360 at time 367, and product D 360 can be repositioned in the lower, silver band 315 at time 367.

In the example of FIG. 3, at time 369 product D's reputation score 210 has increased sufficiently for product D 360 to be repositioned in the higher, gold band 325. In an embodiment, as product D 360 has been previously manually reviewed and accepted for the gold band 325 within a predetermined band allowance timeframe, at time 369 product D 360 is allowed to reenter the gold band 325 without the need for any additional manual review at this time 369.

In an aspect of an embodiment and the example of FIG. 3, if the time 320 between time 365, when product D 360 is first manually reviewed for the gold band 325, and time 369, when product D 360 seeks to reenter the gold band 325, is greater than the band allowance timeframe at time 369 product D 360 is scheduled for a manual review for acceptance into the gold band 325 which product D 360 must once more pass prior to being allowed to reenter the gold band 325.

In another aspect of an embodiment and the example of FIG. 3, if the time 320 between time 365 and time 369 is greater than the band allowance timeframe but product D's reputation score 210 has sufficient velocity then product D 360 can be identified to be pre-reviewed, manually, for reacceptance into the gold band 325 at time 368. In this other aspect of an embodiment if product D 360 once again passes the manual review for the gold band 325 then when product D's reputation score 210 renders product D 360 re-eligible for the gold band 325 at time 369 product D 360 is allowed to be positioned in the gold band 325 at time 369.

In the example of FIG. 3, at time 371 product D's reputation score 210 again falters sufficiently for product D 360 to be reassigned to the lower, silver band 315. In an embodiment, as product D 360 is dropping to a lower reputation band 180 there is no need to manually review product D 360 at this time 371, and product D 360 is repositioned in the lower, silver band 315 at time 371.

In the example of FIG. 3, once product D 360 reenters the silver band 315 at time 371 product D 360 remains positioned within the silver band 315 for the remaining depicted time 320.

In the example of FIG. 3, product E 370, pursuant to an automatically generated or, alternatively, manually, i.e., reviewer 140, assigned initial system assignments 230 value of ninety-five (95) is initially onboarded within the reputation quality control environment 100 in the highest, gold band 325. In an embodiment this system assignments 230 value can be assigned to product E 370 pursuant to a determination rendered by one or more individuals with control within the reputation quality control environment 100 that product E 370 be onboarded and maintained within the quality control environment 100 within the highest, most prestigious, gold band 325.

In the example of FIG. 3 product E 370 remains positioned within the gold band 325 for the entire depicted time 320 pursuant to the maintenance of a system assignments 230 value of ninety-five (95) for product E 370.

As previously discussed, in an embodiment a product 110 is not manually reviewed for a higher reputation band 180 as long as the product 110 has previously passed a manual review for the higher reputation band 180 within a band allowance timeframe. In an embodiment the band allowance timeframe is the same time span, e.g., a week, a month, etc., for each band crossover, e.g., is the same time span for a product 110 to cross from the bronze band 305 to the silver band 315 of FIG. 3 as for the product 110 to cross from the silver band 315 to the gold band 325 of FIG. 3. In an alternative embodiment the band allowance timeframe is different for various band crossovers, e.g., the band allowance timeframe for a product 110 to cross from the bronze band 305 to the silver band 315 is a smaller time span than the band allowance timeframe for a product 110 to cross from the silver band 315 to the gold band 325 of FIG. 3.

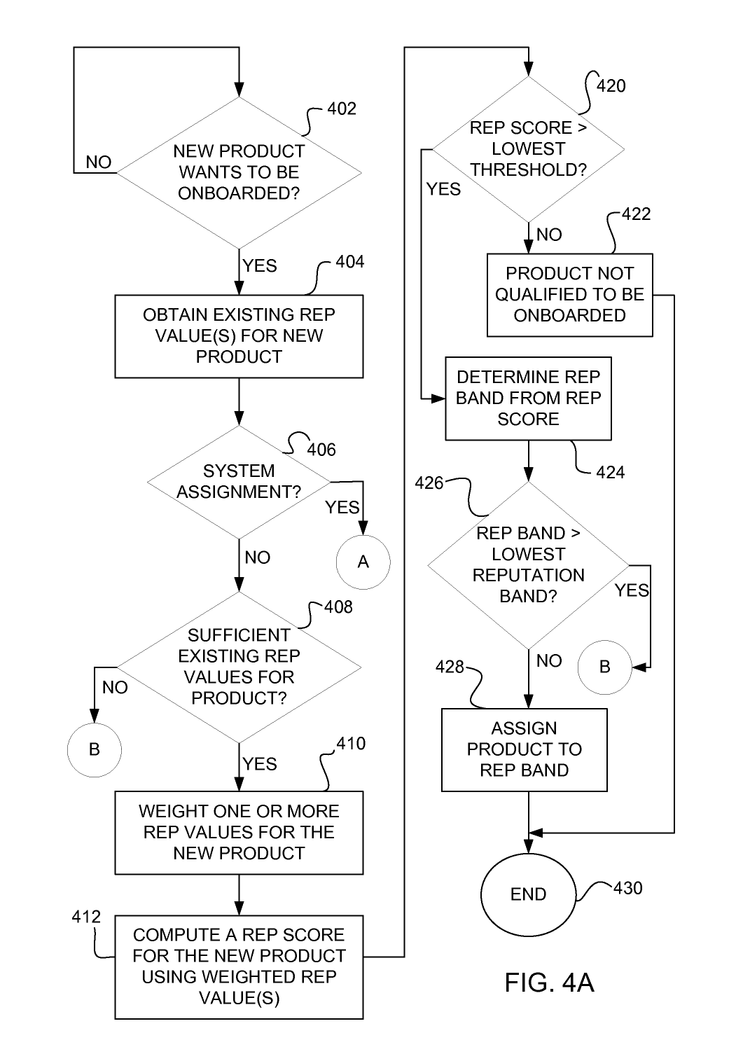

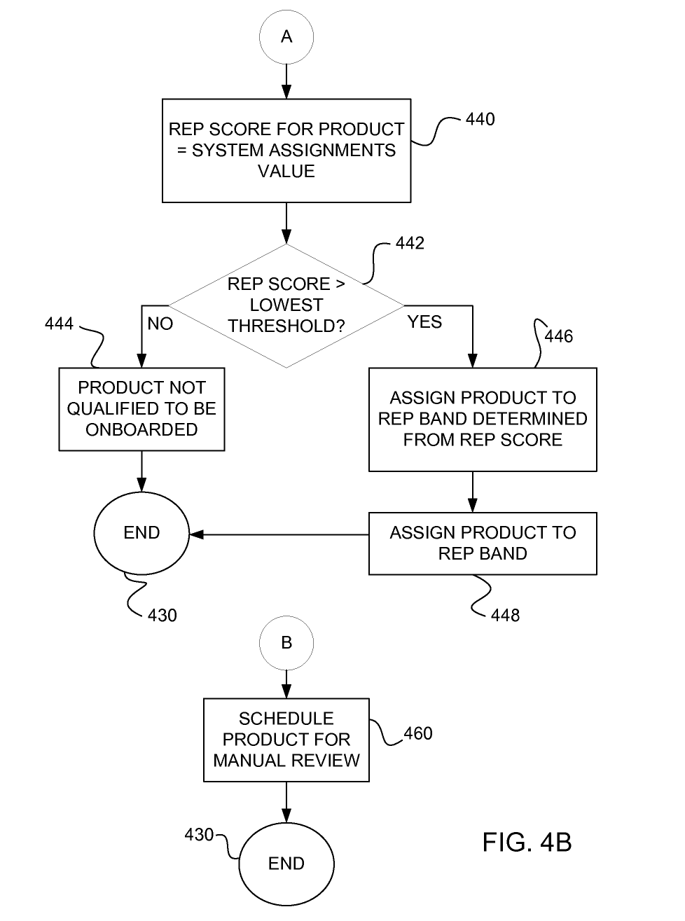

FIGS. 4A-4B illustrate an embodiment logic flow for when a new product 110 is submitted for onboarding, i.e., inclusion, within a reputation quality control environment 100. While the following discussion is made with respect to systems portrayed herein the operations described may be implemented in other systems. The operations described herein are not limited to the order shown. Additionally, in other alternative embodiments more or fewer operations may be performed.

Referring to FIG. 4A, in an embodiment at decision block 402 a determination is made as to whether a new product has been submitted for onboarding. If no, the logic waits for a new product to be submitted for onboarding 402.

If at decision block 402 a new product has been submitted for onboarding in an embodiment one or more existing product reputation values for the product are obtained, or otherwise gathered or collected 404.

In an embodiment at decision block 406 a determination is made as to whether the new product has been given a system assignments value; i.e., whether a system assignments value has been assigned to the product by a reviewer or automated reputation scoring software. As previously noted, in an embodiment a system assignments 230 value is intended to more accurately reflect a valid reputation score 210 for a product 110 than that which is derived utilizing other product reputation values 120, e.g., user ratings 205 value, product returns 245 value, etc. In an embodiment a system assignments 230 value may alternatively create a reputation score 210 for a product 110 and ultimately a product ranking 160 within the reputation scale 170 of the reputation quality control environment 100 that does not exist utilizing other product reputation values 120 but what has been determined to be desired for a particular product 110.

If at decision block 406 there is no system assignments value for the product then in an embodiment at decision block 408 a determination is made as to whether there is sufficient currently existing product reputation values for the product to generate a reliable reputation score. If yes, in an embodiment one or more current product reputation values for the product are weighted 410. In an embodiment a reputation score is computed for the product utilizing one or more current product reputation values and/or weighted current product reputation values 412. In an aspect of this embodiment the reputation score 210 for the product 110 is computed by the execution of software 150.

In an embodiment at decision block 420 a determination is made as to whether the product's reputation score is greater than the lowest threshold value for a product to be onboarded into the reputation quality control environment; i.e., whether the reputation score is of sufficient value that the product can be onboarded at all. If no, the product is not qualified to be onboarded 422, at least at this time, and new product onboard processing is terminated for the product 430.

If at decision block 420 the product's reputation score meets at least the minimum threshold value for onboarding then in an embodiment the reputation band for the product is determined from the product's reputation score 424.

In an embodiment at decision block 426 a determination is made as to whether the reputation band that the product has been determined to be assigned to upon onboarding is greater than the lowest reputation band for the reputation quality control environment. In this embodiment a determination is being made as to whether the calculated reputation score 210 and corresponding reputation band 180 for the new product 110 is greater than the lowest reputation band for the reputation quality control environment 100, e.g., the bronze band 305 of FIG. 3. If no, in an embodiment the product is assigned to the lowest reputation band for the reputation scale of the reputation quality control environment 428 and new product onboard processing is terminated for the product 430.

If at decision block 426 the reputation band that the product has been determined to be assigned to upon onboarding is greater than the lowest reputation band for the reputation quality control environment then in an embodiment and referring to FIG. 4B the product is scheduled for manual review 460 and new product onboard processing is terminated for the product 430. In an aspect of this embodiment the new product is scheduled to be manually reviewed for acceptance into the reputation band that its current reputation score places it in 460.

Referring again to decision block 408 of FIG. 4A, if it is determined that there are insufficient existing product reputation values for the new product to reliably generate a reputation score then in an embodiment and referring to FIG. 4B the product is scheduled for manual review 460 and new product onboard processing is terminated for the product 430. In an aspect of this embodiment the new product is scheduled to be manually reviewed for acceptance into the lowest reputation band of the reputation scale for the reputation quality control environment 460; e.g., the bronze band 305 of FIG. 3.

Referring again to decision block 406 of FIG. 4A, if at this juncture there is a system assignments value for the new product then in an embodiment and referring to FIG. 4B the product's reputation score is set to the system assignments value for the product 440.

In an embodiment at decision block 442 a determination is made as to whether the product's reputation score is greater than the lowest threshold value for a product to be onboarded within the reputation quality control environment; i.e., whether the product's reputation score is of sufficient value that the product can be onboarded at all. If no, the product is not qualified to be onboarded 444, at least at this time, and new product onboard processing is terminated for the product 430.

If at decision block 442 the product's reputation score meets at least the minimum threshold value for onboarding then in an embodiment the reputation band for the product is determined from the product's reputation score 446. In an embodiment the product is assigned to the reputation band of the reputation scale for the reputation quality control environment pursuant to the product's reputation score 448. In an embodiment new product onboard processing is then terminated for the product 430.

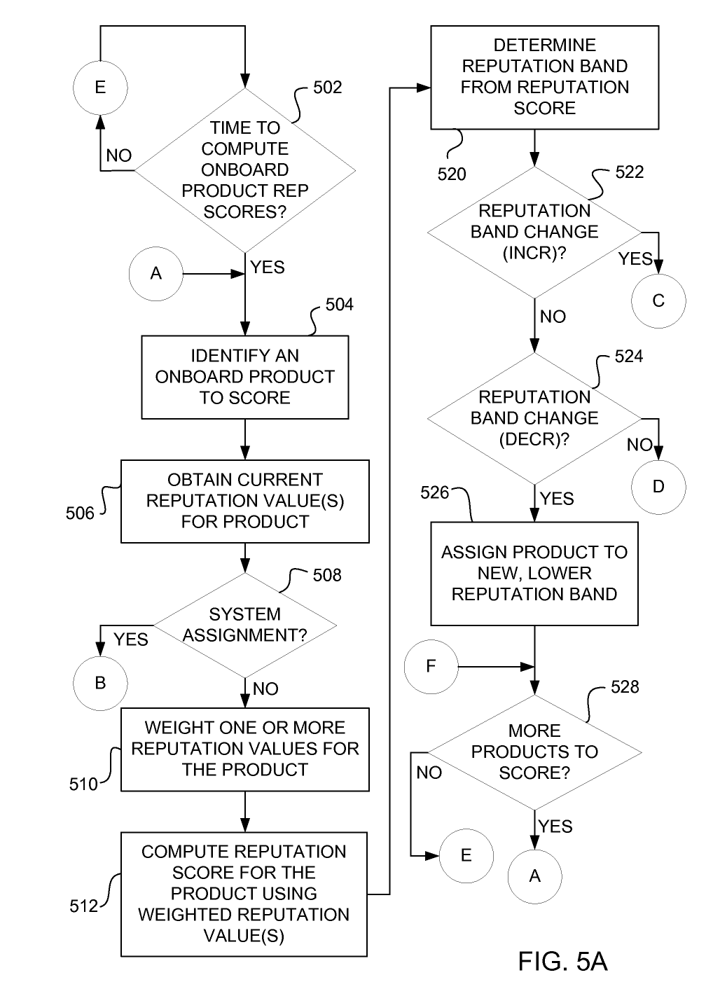

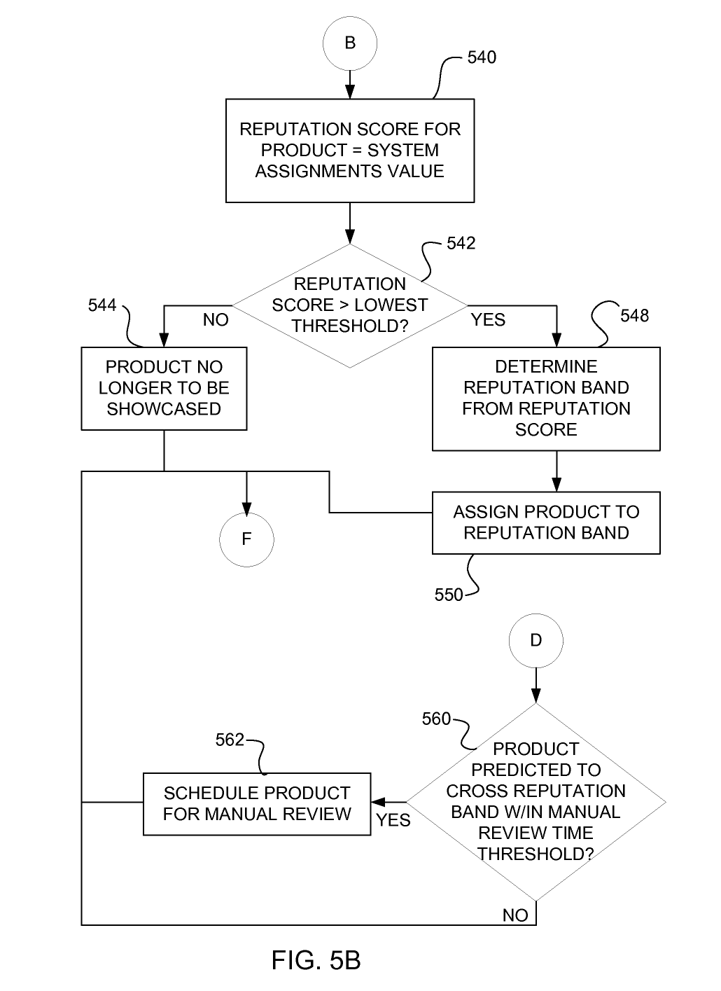

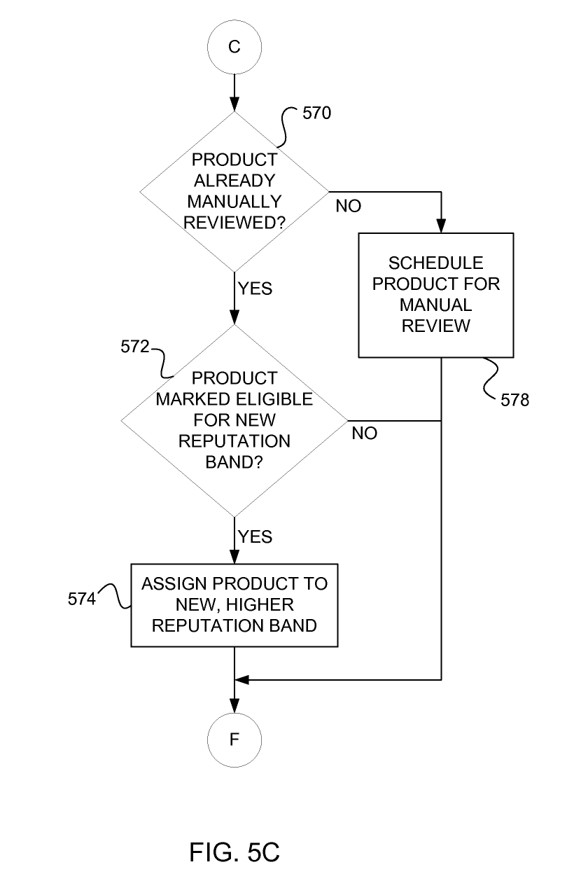

FIGS. 5A-5C illustrate an embodiment logic flow for managing onboard products 110 on a reputation scale 170 of a reputation quality control environment 100. While the following discussion is made with respect to systems portrayed herein the operations described may be implemented in other systems. The operations described herein are not limited to the order shown. Additionally, in other alternative embodiments more or fewer operations may be performed.

In an embodiment at decision block 502 a determination is made as to whether it is currently time to compute onboard product reputation scores, i.e., whether it is the predetermined time to automatically compute reputation scores for products already onboarded within the reputation quality control environment. In an aspect of this embodiment reputation scores 210 and the resultant product rankings 160 for onboard products 110 are automatically computed periodically, e.g., once a day, once a week, etc. In an embodiment reputation scores 210 and the resultant product rankings 160 for onboard products 110 are automatically determined utilizing software, e.g., one or more procedures, 150.

If at decision block 502 it is not time to automatically compute onboard product reputation scores then in an embodiment the logic continues to wait until it is time to compute onboard product reputation scores.

If at decision block 502 it is time to compute onboard product reputation scores then in an embodiment an onboard product is identified to be scored 504. In an aspect of this embodiment the current lowest scored onboard product 110 is first identified to have its reputation score recomputed 504. In an alternative aspect of this embodiment the current highest scored onboard product 110 is first identified to have its reputation score recomputed 504. In still other alternative aspects of this embodiment other criteria are used to identify a first onboard product 110 to automatically compute a reputation score 210 for, e.g., the lowest scored onboard product 110 in a particular reputation band 180, the highest scored onboard product 110 in a particular reputation band 180, the oldest onboard product 110, the most currently onboarded product 110, etc.

In an embodiment current product reputation values are identified, or otherwise obtained, collected or gathered, for the product to be scored 506.

In an embodiment at decision block 508 a determination is made as to whether the product currently being scored has been given a system assignments value; i.e., whether a system assignments value has been assigned to the product by a reviewer or automated product scoring software. As previously noted, in an embodiment a system assignments 230 value is intended to more accurately reflect a valid reputation score 210 for a product 110 than that which is derived utilizing other product reputation values 120, e.g., user ratings 295 value, product returns 245 value, etc. In an embodiment a system assignments 230 value may alternatively create a reputation score 210 for a product 110 and ultimately a product ranking 160 within the reputation scale 170 of the reputation quality control environment 100 that does not exist utilizing other product reputation values 120 but what has been determined to be desired for a particular product 110.

If at decision block 508 there is no system assignments value for the product currently to be scored then in an embodiment one or more current product reputation values for the product are weighted 510. In an embodiment a reputation score is computed for the product utilizing one or more current product reputation values and/or weighted current product reputation values 512.

In an embodiment the reputation band for the newly scored product is determined from the product's reputation score 520.

In an embodiment at decision block 522 a determination is made as to whether the reputation band determined for the product is a higher reputation band than the one the product is currently assigned to. If no, in an embodiment at decision block 524 a determination is made as to whether the reputation band determined for the product is a lower reputation band than the one the product is currently assigned to. If yes, in an embodiment the product is assigned to the new lower reputation band 526.

In an embodiment at decision block 528 a determination is made as to whether there are any more onboard products whose reputation score is to be computed at this periodic time interval. If yes, in an embodiment a next onboard product is identified to be scored 504. If no, in an embodiment the logic returns to decision block 502 where a determination is made as to whether it is the next periodic time to automatically compute onboard product reputation scores.

If at decision block 524 the reputation band determined for the product currently scored is not a lower reputation band than the one the product is currently assigned to then in an embodiment and referring to FIG. 5B at decision block 560 a determination is made as to whether the currently scored product is predicted to cross over into a higher reputation band within a predetermined manual review threshold time interval. Thus, in an embodiment a determination is made as to whether the currently scored product 110 is likely to obtain a reputation score 210 that will position it within the next higher reputation band 180 within a predetermined time interval, e.g., the manual review threshold time interval, given its current reputation score 210 and the rate of ascent that its reputation score 210 has been making.

If at decision block 560 it is determined that the currently scored product is on target to cross into a higher reputation band within the manual review threshold time interval then in an embodiment the product is scheduled for manual product review 562. In an aspect of this embodiment the currently scored product is scheduled for a manual review for acceptance into the new higher reputation band that it is on target to cross into within the manual review threshold time interval 562.

For example, assume that the maximum reputation score velocity for a product 110 in a reputation quality control environment 100 is four (4) points; i.e., the maximum reputation score 210 increase a product 110 can make from one computation period to the next is four (4). Also assume that it has been determined that a two (2) day buffer is needed for adequately accommodating manual product reviews. Thus, the manual review threshold time interval is eight (4×2=8). In this example and embodiment a product 110 that currently has a reputation score eight (8) points or less from the next reputation band, e.g., eight (8) points or less from a score of eighty-one (81) that marks the low threshold value of exemplary gold band 325 of FIG. 3, is scheduled for manual product review 562.

In an alternative embodiment there may be different time buffers needed for adequately accommodating manual product reviews for products 110 to enter differing reputation bands 180. Thus, for example, there may be a two (2) day buffer for adequately accommodating manual reviews for products 110 attempting to enter the silver band 315 of FIG. 3 while there may be a four (4) day buffer required for adequately accommodating manual reviews for products 110 seeking to enter the gold band 325 of FIG. 3. In this alternative embodiment then, a product that has a reputation score of eight (8) points or less from the lowest threshold value, e.g., fifty-one (51), of the silver band 315 of FIG. 3 will be scheduled for a manual product review 562 while a product that has a reputation score of sixteen (16) points or less from the lowest threshold value, e.g., eighty-one (81), of the gold band 325 of FIG. 3 will be scheduled for a manual product review 562.

Whether or not the currently scored product is on target to cross into a higher reputation band within the manual review threshold time interval in an embodiment and referring to FIG. 5A at decision block 528 a determination is made as to whether there are any more onboard products whose reputation score is to be computed at this periodic time interval.

Referring again to FIG. 5A, if at decision block 522 the reputation band for the currently scored product has increased pursuant to the product's newly generated reputation score then in an embodiment and referring to FIG. 5C at decision block 570 a determination is made as to whether the product has already been manually reviewed for the new reputation band. If no, in an embodiment the product is scheduled for manual review for acceptance into the new, higher reputation band 578. In an embodiment the logic returns to decision block 528 of FIG. 5A where a determination is made as to whether there are any more onboard products whose reputation score is to be computed at this periodic time interval.

If at decision block 570 of FIG. 5C the currently scored product has already been manually reviewed for the new, higher reputation band then in an embodiment at decision block 572 a determination is made as to whether the product has been marked eligible for the new reputation band; i.e., whether the product 110 passed the manual review for acceptance into the new, higher reputation band 180. If yes, in an embodiment the product is assigned to the new, higher reputation band 574. Alternatively, if the product 110 has not been marked eligible for the new reputation band 180 then it will remain positioned within its currently assigned reputation band 180.

Whether or not the product is eligible for the new, higher reputation band in an embodiment and referring again to FIG. 5A at decision block 528 a determination is made as to whether there are any more onboard products whose reputation score is to be computed at this periodic time interval.

Referring to FIG. 5A, if at decision block 508 the current product identified for scoring has a system assignments value then in an embodiment and referring to FIG. 5B the product's reputation score is set to the system assignments value for the product 540.

In an embodiment at decision block 542 a determination is made as to whether the reputation score for the product is greater than the lowest threshold value for a product to be onboarded into the reputation quality control environment; i.e., whether the product's reputation score is of sufficient value that the product can be or can continue to be onboarded at all. If no, the product is no longer qualified to be onboarded, at least at this time, and will no longer be included within the reputation scale of the reputation quality control environment 544.

In an embodiment and referring again to FIG. 5A at decision block 528 a determination is made as to whether there are any more onboard products whose reputation score is to be computed at this periodic time interval.

If at decision block 542 the product's reputation score meets at least the minimum threshold value for onboarding within the reputation quality control environment then in an embodiment the reputation band for the product is determined from the product's reputation score 548. In an embodiment the product is assigned to the reputation band of the reputation scale for the reputation quality control environment pursuant to the product's current reputation score 550.

In an embodiment and referring again to FIG. 5A, at decision block 528 a determination is made as to whether there are any more onboard products whose reputation score is to be computed at this periodic time interval.

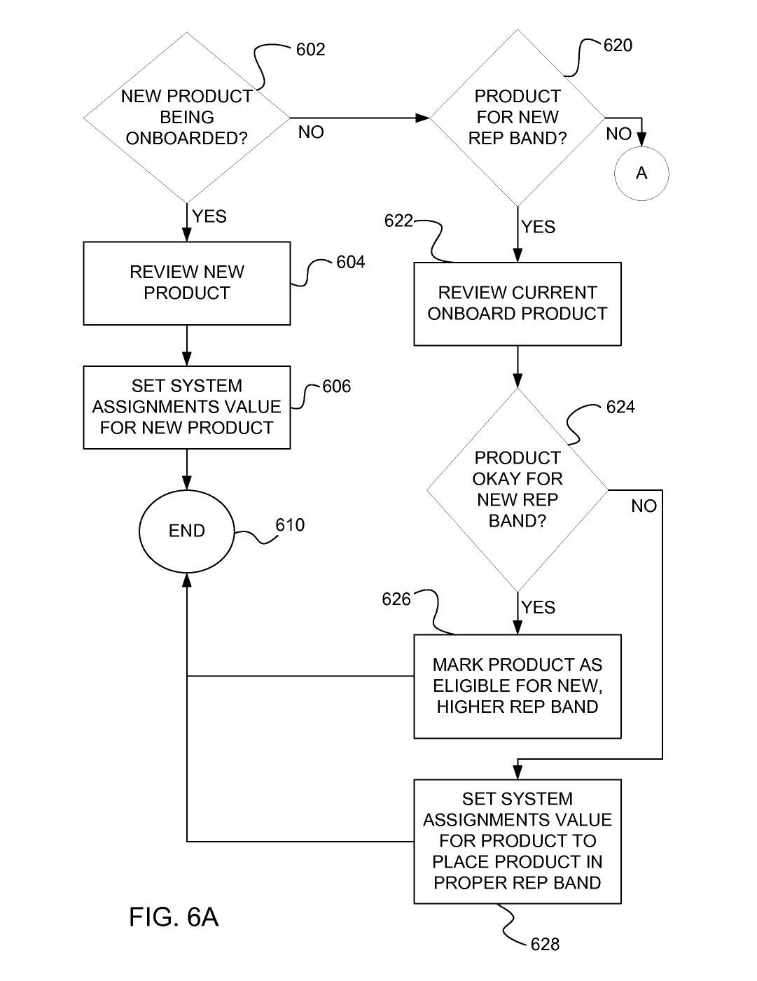

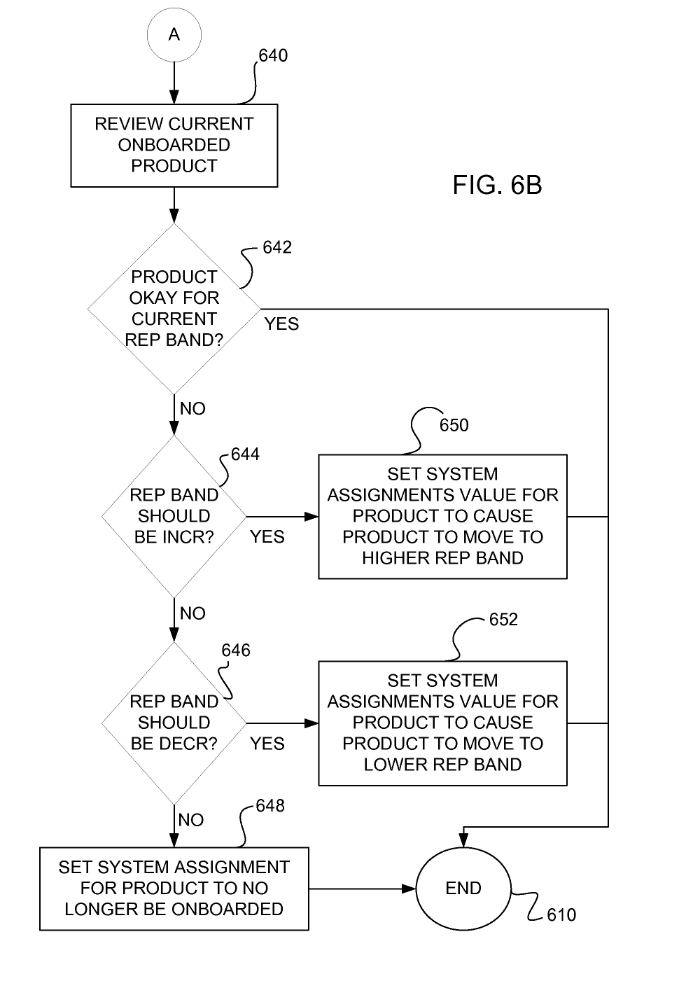

FIGS. 6A-6B illustrate an embodiment logic flow for incorporating manual determinations, e.g., reviews, scoring, ratings, etc., within an embodiment reputation quality control environment 100. While the following discussion is made with respect to systems portrayed herein the operations described may be implemented in other systems. The operations described herein are not limited to the order shown. Additionally, in other alternative embodiments more or fewer operations may be performed.

Referring to FIG. 6A, in an embodiment at decision block 602 a determination is made as to whether the current product to be manually reviewed is being onboarded, i.e., whether it is a new product seeking to be included within the reputation quality control environment. If yes, in an embodiment the product is manually reviewed 604. In an aspect of this embodiment the product 110 attempting to be onboarded is manually reviewed by one or more reviewers 140.

In an aspect of this embodiment the product attempting to be onboarded is manually reviewed for the lowest reputation band in the reputation quality control environment 604. In an alternative aspect of this embodiment the product attempting to be onboarded is manually reviewed for a predetermined reputation band in the reputation quality control environment 604. In this alternative aspect new onboard products 110 can be introduced into a reputation band 180 that is higher than the lowest reputation band 180 of the reputation scale 170 of the reputation quality control environment 100.

In an embodiment a reviewer sets a system assignments value for the newly reviewed product that will establish the reputation band the new product will first be positioned within 606. In an embodiment manual review of the new product is ended 610.

If at decision block 602 it is not a new product seeking to be onboarded then in an embodiment at decision block 620 a determination is made as to whether the manual review is for a currently onboarded product seeking to enter a new, higher reputation band or will soon be seeking to enter a new, higher reputation band. If yes, in an embodiment the product is manually reviewed for the new, higher reputation band 622.

In an embodiment at decision block 624 a determination is made as to whether the product has passed the manual review for the new, higher reputation band; i.e., whether the product can be allowed to enter the new reputation band. If yes, the product is marked eligible for the new reputation band 626 and manual review of the product is ended 610.

If at decision block 624 the product has failed the manual review for entering the new, higher reputation band in an embodiment a system assignments value is assigned the product for causing the product to be positioned within the proper reputation band based on the manual review 628. In an embodiment manual review of the product is ended 610.

If at decision block 620 the manual review is not for a product currently seeking to enter a new, higher reputation band then in an embodiment and referring to FIG. 6B the manual review is a scheduled manual review for one or more currently onboarded products. In an embodiment groups of one or more onboarded products 110 are periodically manually reviewed to ensure the integrity of the reputation scale 170 and the reputation quality control environment 100. In an aspect of this embodiment the onboarded products 110 that are manually reviewed during any particular periodic manual review are randomly selected. In alternative aspects of this embodiment the onboarded products 110 that are manually reviewed during any particular periodic manual review are selected based on one or more predetermined criteria, e.g., the five (5) onboarded products 110 who have never been manually reviewed or who otherwise have gone the longest since being manually reviewed; the ten (10) onboarded products 110 that have been onboarded the longest; etc.

In an embodiment an onboard product is manually reviewed 640. In an embodiment at decision block 642 a determination is made as to whether the product has passed the manual review for its currently assigned reputation band; i.e., whether the product is properly positioned within its current reputation band based on the manual review. If yes, in an embodiment manual review of the product is ended 610.

If at decision block 642 the currently reviewed product is not properly positioned in its current reputation band then at decision block 644 a determination is made as to whether the manual review has determined that the product should be repositioned in a new, higher reputation band. If yes, in an embodiment a system assignments value is assigned the product to cause the product to be positioned within the higher reputation band 650. In an embodiment manual review of the product is ended 610.

If at decision block 644 the currently reviewed product should not be moved to a higher reputation band then in an embodiment at decision block 646 a determination is made as to whether the manual review has determined that the product should be moved to a new, lower reputation band. If yes, in an embodiment a system assignments value is assigned to the product to cause the product to be positioned within the lower reputation band 652. In an embodiment manual review of the product is ended 610.

If at decision block 646 the currently reviewed product should not be moved to a lower reputation band then in an embodiment the manual review has determined that the product should no longer be onboarded within the reputation quality control environment. In an embodiment in this situation a system assignments value is assigned to the product to cause the product to be removed from the reputation quality control environment 648. In an embodiment manual review of the product is ended 610.

### Computing Device Configuration

FIG. 7 is a block diagram that illustrates an exemplary computing device 700 upon which embodiments described herein can be implemented.

The embodiment computing device 700 includes a bus 705 or other mechanism for communicating information, and a processing unit 710, also referred to herein as a processor 710, coupled with the bus 705 for processing information. The computing device 700 also includes system memory 715, which may be volatile or dynamic, such as random access memory (RAM), non-volatile or static, such as read-only memory (ROM) or flash memory, or some combination of the two. The system memory 715 is coupled to the bus 705 for storing information and instructions to be executed by the processor 710, and may also be used for storing temporary variables or other intermediate information during the execution of instructions by the processor 710. The system memory 715 often contains an operating system and one or more programs 150, or applications or procedures, and/or software code, and may also include program data.

In an embodiment a storage device 720, such as a magnetic or optical disk, is also coupled to the bus 705 for storing information, including program code 150 of instructions and/or data. In an embodiment computing device 700 the storage device 720 is computer readable storage, or machine readable storage.

Embodiment computing devices 700 generally include one or more display devices 735, such as, but not limited to, a display screen, e.g., a cathode ray tube (CRT) or liquid crystal display (LCD), a printer, and one or more speakers, for providing information to a computing device user, also referred to herein as reviewer 140. Embodiment computing devices 700 also generally include one or more input devices 730, such as, but not limited to, a keyboard, mouse, trackball, pen, voice input device(s), and touch input devices, which a user 140 can utilize to communicate information and command selections to the processor 710. All of these devices are known in the art and need not be discussed at length here.

The processor 710 executes one or more sequences of one or more programs 150, or applications or procedures, and/or software code instructions contained in the system memory 715. These instructions may be read into the system memory 715 from another computing device-readable medium, including, but not limited to, the storage device 720. In alternative embodiments, hard-wired circuitry may be used in place of or in combination with software instructions. Embodiment computing device 700 environments are not limited to any specific combination of hardware circuitry and/or software.

The term “computing device-readable medium” as used herein refers to any medium that can participate in providing program 150, or application, and/or software instructions to the processor 710 for execution. Such a medium may take many forms, including but not limited to, storage media and transmission media. Examples of storage media include, but are not limited to, RAM, ROM, EEPROM, flash memory, CD-ROM, digital versatile disks (DVD), magnetic cassettes, magnetic tape, magnetic disk storage, or any other magnetic medium, floppy disks, flexible disks, punch cards, paper tape, or any other physical medium with patterns of holes, memory chip, or cartridge. The system memory 715 and storage device 720 of embodiment computing devices 700 are further examples of storage media. Examples of transmission media include, but are not limited to, wired media such as coaxial cable(s), copper wire and optical fiber, and wireless media such as optic signals, acoustic signals, RF signals and infrared signals.

An embodiment computing device 700 also includes one or more communication connections 750 coupled to the bus 705. Embodiment communication connection(s) 750 provide a two-way data communication coupling from the computing device 700 to other computing devices on a local area network (LAN) 765 and/or wide area network (WAN), including the world wide web, or internet, 770 and various other communication networks 775, e.g., SMS-based networks, telephone system networks, etc. Examples of the communication connection(s) 750 include, but are not limited to, an integrated services digital network (ISDN) card, modem, LAN card, and any device capable of sending and receiving electrical, electromagnetic, optical, acoustic, RF or infrared signals.

Communications received by an embodiment computing device 700 can include program 150, or application and/or software instructions, and data. Instructions received by the embodiment computing device 700 may be executed by the processor 710 as they are received, and/or stored in the storage device 720 or other non-volatile storage for later execution.

### CONCLUSION

While various embodiments are described herein, these embodiments have been presented by way of example only and are not intended to limit the scope of the claimed subject matter. Many variations are possible which remain within the scope of the following claims. Such variations are clear after inspection of the specification, drawings and claims herein. Accordingly, the breadth and scope of the claimed subject matter is not to be restricted except as defined with the following claims and their equivalents.

What is claimed is:

1. A method for quality control of product positioning within a reputation scale for a reputation quality control environment comprising at least one product, the method comprising:
periodically generating a reputation score for a first product of the reputation quality control environment;
positioning the first product within a first reputation band of the reputation scale, wherein the reputation scale comprises at least two reputation bands, and wherein each reputation band comprises at least two consecutive reputation scores;
determining that the first product may attempt to gain access to a second reputation band of the reputation scale within a predefined timeframe;
scheduling the first product for a manual review upon determining that the first product may attempt to gain access to the second reputation band of the reputation scale within the predefined timeframe;
performing a manual review of the first product subsequent to scheduling the first product for a manual review;
marking the first product as eligible for the second reputation band as a result of the manual review of the first product when the manual review of the first product determines that the first product is acceptable for the second reputation band; and
allowing the first product to be positioned within the second reputation band when the reputation score for the first product is at least as great as the minimum threshold value for the second reputation band and the first product has been marked as eligible for the second reputation band, wherein the second reputation band is delimited between a minimum threshold value and a maximum threshold value and wherein the minimum threshold value for the second reputation band is the smallest reputation score within the second reputation band and wherein the maximum threshold value for the second reputation band is the largest reputation score for the second reputation band.

2. The method for quality control of product positioning within a reputation scale for a reputation quality control environment of claim 1, further comprising forbidding the first product to be positioned within the second reputation band when the reputation score for the first product is at least as great as the minimum threshold value for the second reputation band and the first product is not marked as eligible for the second reputation band.

3. The method for quality control of product positioning within a reputation scale for a reputation quality control environment of claim 1, further comprising:
determining that the first product may attempt to gain access to a third reputation band of the reputation scale within a predefined timeframe;
scheduling the first product for a manual review upon determining that the first product may attempt to gain access to the third reputation band of the reputation scale within the predefined timeframe;
performing a manual review of the first product for acceptance into the third reputation band subsequent to scheduling the first product for a manual review, wherein the manual review of the first product for acceptance into the third reputation band comprises different criteria for the product to be marked as eligible for the third reputation band than the manual review of the first product that was performed for acceptance into the second reputation band;
marking the first product as eligible for the third reputation band as a result of the manual review of the first product when the manual review of the first product determines that the first product is acceptable for the third reputation band; and
allowing the first product to be positioned within the third reputation band when the reputation score for the first product is at least as great as the minimum threshold value for the third reputation band and the first product has been marked as eligible for the third reputation band, wherein the third reputation band is delimited between a minimum threshold value and a maximum threshold value and wherein the minimum threshold value for the third reputation band is the smallest reputation score within the third reputation band and wherein the maximum threshold value for the third reputation band is the largest reputation score for the third reputation band.

4. The method for quality control of product positioning within a reputation scale for a reputation quality control environment of claim 3, further comprising forbidding the first product to be positioned within the third reputation band when the reputation score for the first product is at least as great as the minimum threshold value for the third reputation band and the first product is not marked as eligible for the third reputation band.

5. The method for quality control of product positioning within a reputation scale for a reputation quality control environment of claim 1, further comprising:
repositioning the first product within the first reputation band of the reputation scale when the reputation score for the first product becomes smaller than the minimum threshold value for the second reputation band; and,
subsequently repositioning the first product within the second reputation band of the reputation scale when the reputation score for the first product becomes equal to the minimum threshold value for the second reputation band, wherein repositioning the first product within the second reputation band does not require another manual review of the product for acceptance into the second reputation band; and
subsequently repositioning the first product within the second reputation band of the reputation scale when the reputation score for the first product becomes greater than the minimum threshold value for the second reputation band, wherein repositioning the first product within the second reputation band does not require another manual review of the product for acceptance into the second reputation band.

6. The method for quality control of product positioning within a reputation scale for a reputation quality control environment of claim 5, wherein repositioning the first product within the second reputation band of the reputation scale does not require another manual review of the product for acceptance into the second reputation band when the first product has been manually reviewed for the second reputation band within a predetermined second band review timeframe.

7. The method for quality control of product positioning within a reputation scale for a reputation quality control environment of claim 1, further comprising:
generating an initial reputation score for each product that seeks to be onboarded within the reputation quality control environment;
assigning each product that seeks to be onboarded within the reputation quality control environment to a reputation band of the reputation scale when the initial reputation score for the product is at least a minimum scale value; and
declining to onboard a product that seeks to be onboarded within the reputation quality control environment when the initial reputation score for the product is less than the minimum scale value.

8. The method for quality control of product positioning within a reputation scale for a reputation quality control environment of claim 7, wherein the assignment of a product that seeks to be onboarded within the reputation quality control environment to a reputation band of the reputation scale is determined by the initial reputation score for the product.

9. The method for quality control of product positioning within a reputation scale for a reputation quality control environment of claim 7, wherein the assignment of a product that seeks to be onboarded within the reputation quality control environment to a reputation band of the reputation scale is the reputation band of the reputation scale that comprises the smallest reputation scores of the reputation scale.

10. The method for quality control of product positioning within a reputation scale for a reputation quality control environment of claim 1, wherein the reputation scale comprises a range of at least six reputation scores, wherein the first reputation band of the reputation scale comprises a range of at least two reputation scores comprising the smallest reputation scores for the reputation scale, wherein the second reputation band of the reputation scale comprises a range of at least two reputation scores comprising the median reputation scores of the reputation scale, wherein the median reputation scores of the reputation scale comprise reputation scores that are larger than the smallest reputation scores comprising the first reputation band and that are smaller than the reputation scores in a range of the largest reputation scores for the reputation scale, and wherein a third reputation band of the reputation scale comprises the range of the largest reputation scores for the reputation scale, wherein the range of the largest reputation scores for the reputation scale comprise at least two reputation scores.

11. The method for quality control of product positioning within a reputation scale for a reputation quality control environment of claim 10, wherein a second reputation band manual review of a product is performed for the first product prior to the first product being positioned within the second reputation band of the reputation scale, a third reputation band manual review of a product is performed for the first product prior to the first product being positioned within the third reputation band of the reputation scale, and wherein the third reputation manual review comprises the first product meeting at least one more criteria for acceptance into the third reputation band than is required for the first product to meet in the second reputation band manual review for acceptance into the second reputation band.

12. The method for quality control of product positioning within a reputation scale for a reputation quality control environment of claim 11, further comprising performing a first reputation band manual review of the first product prior to positioning the first product within the first reputation band, wherein the first reputation band manual review comprises a set of at least one criteria that the first product must meet, and wherein the second reputation manual review comprises a set of criteria that the first product must meet that comprises at least one more criteria than the set of at least one criteria for the first reputation band manual review.

13. The method for quality control of product positioning within a reputation scale for a reputation quality control environment of claim 1, further comprising
periodically generating a reputation score for each product of the reputation quality control environment;
removing a product from the reputation quality control environment when its reputation score falls below a minimum reputation scale score; and
removing a product from the reputation quality control environment when a manual review of the product determines that the product is unacceptable for the reputation quality control environment.

14. The method for quality control of product positioning within a reputation scale for a reputation quality control environment of claim 1, wherein the reputation quality control environment comprises an online store for purchasing products and wherein the products of the reputation quality control environment comprise software products.

15. A method for reputation scale quality control in a reputation quality control environment comprising at least one product, wherein the reputation scale comprises at least two reputation bands, and wherein each reputation band comprises a range of at least two reputation scores, wherein a first reputation score of a reputation band comprises the minimum score for the reputation band and wherein a second reputation score of a reputation band comprises the maximum score for the reputation band, the method comprising:
generating an initial reputation score for each product that seeks to be onboarded within the reputation quality control environment;
assigning each product that seeks to be onboarded within the reputation quality control environment to a reputation band of the reputation scale when the initial reputation score for the product is at least a minimum reputation scale value;
declining to onboard a product that seeks to be onboarded within the reputation quality control environment when the initial reputation score for the product is less than the minimum reputation scale value;
periodically generating a reputation score for each product onboarded within the reputation quality control environment;
determining that a first product of the reputation quality control environment may attempt to gain access to a second reputation band of the reputation scale within a predefined timeframe;
scheduling the first product for a manual review upon determining that the first product may attempt to gain access to the second reputation band of the reputation scale within the predefined timeframe;
performing a manual review of the first product subsequent to scheduling the first product for a manual review;
marking the first product as eligible for the second reputation band as a result of the manual review of the first product when the manual review of the first product determines that the first product is acceptable for the second reputation band;
positioning the first product within the second reputation band when the reputation score for the first product is at least as great as the minimum score for the second reputation band and the first product has been marked as eligible for the second reputation band as a result of the manual review; and
declining to position the first product within the second reputation band when the reputation score for the first product is at least as great as the minimum score for the second reputation band and the first product is not marked as eligible for the second reputation band as a result of the manual review.

16. The method for reputation scale quality control in a reputation quality control environment of claim 15, the method further comprising:
determining that the first product may attempt to gain access to a third reputation band of the reputation scale within a predefined timeframe;
scheduling the first product for a second manual review upon determining that the first product may attempt to gain access to the third reputation band of the reputation scale within the predefined timeframe;
performing a second manual review of the first product for acceptance into the third reputation band subsequent to scheduling the first product for a second manual review;
marking the first product as eligible for the third reputation band as a result of the second manual review of the first product when the second manual review of the first product determines that the first product is acceptable for the third reputation band; and
positioning the first product within the third reputation band when the reputation score for the first product is at least as great as the minimum score for the third reputation band and the first product is marked as eligible for the third reputation band.

17. The method for reputation scale quality control in a reputation quality control environment of claim 15, the method further comprising:
periodically manually reviewing a set of at least one product onboarded within the reputation quality control environment, wherein the set of at least one product comprises products that have not been manually reviewed within a predetermined manual review timeframe;
manually setting a new reputation score for a product that is manually reviewed when the manual review of the product determines that the reputation score for the product is inaccurate; and
positioning a product with a new reputation score that is manually set within a different reputation band of the reputation scale than the reputation band the product is positioned in prior to being manually reviewed.

18. The method for reputation scale quality control in a reputation quality control environment of claim 15, wherein the reputation quality control environment comprises an online store for purchasing products and wherein the products of the reputation quality control environment comprise software products.

19. A reputation quality control environment for ranking products onboarded within the reputation quality control environment, the reputation quality control environment comprising:
a reputation scale comprising at least two reputation bands;
at least one product onboarded within the reputation quality control environment;
a procedure for automatically generating a reputation score for at least one product onboarded within the reputation quality control environment;
a procedure for utilizing a reputation score for a product to position the product within a reputation band of the reputation scale;
a procedure for automatically generating a reputation score for at least one product that is seeking to be onboarded within the reputation quality control environment;
a procedure for utilizing a reputation score for a product that is seeking to be onboarded within the reputation quality control environment to position the product seeking to be onboarded within the reputation quality control environment within a reputation band of the reputation scale;
a procedure for determining that a product may attempt to gain access to a different reputation band of the reputation scale than the reputation band the product is currently positioned in within a predefined manual review threshold time interval;
a procedure for automatically scheduling a product for a manual review for the different reputation band upon determining that the product may attempt to gain access to the different reputation band of the reputation scale within the predefined manual review threshold time interval; and
a procedure for automatically positioning a product in a different reputation band when a reputation score for the product is within the different reputation band and the product has passed a manual review for the different reputation band.

20. The reputation quality control environment of claim 19, wherein the reputation quality control environment comprises an online store for purchasing products, the products of the reputation quality control environment comprise software products, and wherein the procedure for automatically scheduling a product for a manual review for a different reputation band upon determining that the product may attempt to gain access to the different reputation band of the reputation scale within the predefined manual review threshold time interval comprises automatically scheduling the product for manual review for the different reputation band when the different reputation band is a reputation band comprising larger reputation scores than the reputation band the product is currently positioned within and when the product has not been manually reviewed for the different reputation band within a band allowance timeframe.
